(19) United States
(12) Patent Application Publication
(10) Pub. No.: US 2014/0351257 A1
(43) Pub. Date: Nov. 27, 2014

(54) VOTING AND EXPIRING SYSTEM TO RANK INTERNET CONTENT

(71) Applicant: Matthew Zuzik, Jupiter, FL (US)

(72) Inventor: Matthew Zuzik, Jupiter, FL (US)

(21) Appl. No.: 13/899,789

(22) Filed: May 22, 2013

(51) Int. Cl. H04L 29/08; G06F 17/30

(52) U.S. Cl. CPC H04L 67/10; G06F 17/3089
USPC 707/740; 709/206; 707/749

(57) ABSTRACT

A method and system for delivering highly relevant content, and removing irrelevant content, to a community of users over a conversational network platform. The embodiments of the present disclosure allow user-submitted content to be dynamically organized by “most trending” or “most important” by aggregating and evaluating user votes. User votes may expire according to a specified period of time to allow the system to determine relevancy of the content. An embodiment provides a forum for users to view and contribute content specifically tailored to individual entities, such that every instance of system content (including comments and votes) is related to one specific entity.

### RELATED APPLICATIONS

This application claims the benefit and priority of U.S. Provisional Application 61/696,010, filed on Aug. 31, 2012, hereby incorporated by reference in its entirety.

### FIELD

The present invention is generally related to a method and system to deliver targeted content over a social media forum. More particularly, the present invention is directed to delivering highly relevant content, and removing irrelevant content, to a community of users over a conversational network platform.

### BACKGROUND

The Internet is increasingly used as a platform for social media. Examples of social media include social networks, blogging systems, media sharing platforms, online forums, and meme aggregators. Social media is based on widely available tools that provide users the ability to create links and trackbacks that tent to foster and describe their trust relationships. There are several aspects of social media that fosters trust relationships. One aspect of social media that fosters trust relationships is the level of dedication of individual publishers. Publishing social media content is an expression of unique interest in a topic. Individuals participating in a conversation around this content invest time to read, trackback, tag, rate, and/or comment on what is being shared. The level of dedication of the publishers of social media and individuals participating in conversation around it is one factor that promotes trust within social media. The trust relationships also develop die to the ability of individuals participating in a conversation to comment about posting, add content, and correct errors. Additionally, social media permits links to be established between publishers. The links between publishers foster the spread of ideas ad also permits rapid feedback within the community. Moreover, in social media influential and/or trusted publishers and other participants in the conversation can lend their weight to the veracity of the posting of other publishers, via links, comments, voting, and the like.

One aspect of social media is that it is highly conversational in nature. Most social media and social network websites allow one entity to be followed by many users so that entity can quickly communicate a post to a large community of followers. The messages sent out by these entities, or publishers, are ordered by when they were typed, sent, and delivered; and may not be of any relevance to the entity's followers. Unless the follower is watching what the user is commenting about continuously, more often than not important or interesting posts are completely missed or ignored. Additionally, while most social media websites allow followers to respond to comments, there is no way of highlighting popular or trending comments to that entity or within the conversational community. Given the popularity of many social media platforms and websites, there are often significant amounts of irrelevant or otherwise voluminous content postings that contribute very little to a topic or conversation.

What is needed, therefore, is a method for delivering highly targeted content to a user or entity, while reducing the amount of irrelevant or voluminous content over a forum.

### SUMMARY

An object of the present disclosure is a system for targeted social media content ranking comprising a content classification module, the content classification module being configured to accept a content input from a communications interface and classify the content input based on system and user parameters to determine content input relevance; a multidimensional database engine, the multidimensional database engine being configured to store content input across dimensional hierarchies according to content category parameters communicated by the content classification module; an applications module configured to display the content input stored in the multidimensional database engine across one or more Web pages, and accept a user action on displayed content over a graphical user interface; and, an expiration module configured to aggregate the user actions on displayed content, the expiration module further comprising a timing module configured to assign a time limit on content input display over the applications module in response to the user action, the expiration module configured to remove content from the applications module in response to an expired content time limit.

Another object of the present disclosure is a system for analyzing a social media of postings published over a Web platform comprising an aggregation module, the aggregation module configured to aggregate content threads and sub-threads of social media postings, and a plurality of votes submitted by Internet users in response to the content threads and sub-threads; and, a timing module, the timing module configured to assign a timer to the content threads and sub-threads in response to submission by an Internet user over the Web platform, the timer being reset in response to a vote submission, and further configured to remove content from the Web platform in response to timer expiration.

Still another object of the present disclosure is computer-implemented method for delivering targeted social media content to a user comprising aggregating comments and user votes in response to a social media posting; ranking the social media posting based on comment and user vote parameters, the parameters being manipulated dynamically based on content classification and system administrator settings; displaying the social media posting over one or more Web pages according to ranking parameters; and, removing the social media posting from the one or more Web pages according to relevance parameters determined by a timing module, the timing module being configured to set a relevance time limit according to a frequency of comments and user votes in response to the social media posting.

Further embodiments, features, and advantages of the invention, as well as the structure and operation of the various embodiments of the invention are described in detail below with reference to the accompanying drawings.

### BRIEF DESCRIPTION OF DRAWINGS

The components of the following figures are illustrated to emphasize the general principles of the present disclosure. Reference characters designating corresponding components are repeated as necessary throughout the figures for the sake of consistency and clarity.

FIG. 1 is a block diagram of a voting and expiring Internet content ranking system in accordance with an embodiment.

FIG. 2 is a logical flow diagram illustrating a voting and expiring Internet content ranking system in accordance with an embodiment.

FIG. 3 is a logical flow diagram illustrating a routine of a voting and expiring Internet content ranking system in accordance with an embodiment.

FIG. 4 is a logical flow diagram illustrating a routine of a voting and expiring Internet content ranking system in accordance with an embodiment.

FIG. 5 is a logical flow diagram illustrating a routine of a voting and expiring Internet content ranking system in accordance with an embodiment.

FIG. 6 is a diagram of a graphical user interface (GUI) for viewing targeted content and account settings in a social media platform in accordance with an embodiment.

FIG. 7 is a diagram of a GUI for viewing targeted content and account settings in a social media platform in accordance with an embodiment.

FIG. 8 is a diagram of a GUI for adding targeted content in a social media platform in accordance with an embodiment.

FIG. 9a is a diagram of a GUI for viewing content expiration and voting values in a social media platform in accordance with an embodiment.

FIG. 9b is a diagram of a GUI for viewing comment statistics in a social media platform in accordance with an embodiment.

FIG. 9c is a diagram of a GUI for viewing user-targeted content in a social media platform in accordance with an embodiment.

FIG. 10 is a diagram of a GUI for viewing user-targeted content in a social media platform in accordance with an embodiment.

FIG. 11 is a diagram of a GUI for viewing user-submitted content in a social media platform in accordance with an embodiment.

FIG. 12 is a diagram of a GUI for responding to user-submitted content in a social media platform in accordance with an embodiment.

### DETAILED DESCRIPTION

Reference will now be made in detail to various embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of various embodiments of the present invention, numerous specific details are set forth in order to provide a thorough understanding of the present invention. In other instances, well-known methods, procedures, protocols, services, components, and circuits have not been described in detail so as not to unnecessarily obscure aspects of the present invention.

The embodiments of the present disclosure describe systems and methods for delivering targeted Internet content to a community of social media users by allowing users to vote on platform content, and the system to remove irrelevant content from the platform in response to expired votes or content. The embodiments of the present disclosure allow user-submitted content to be dynamically organized by “most trending” or “most important” by aggregating and evaluating user votes. User votes may expire according to a specified period of time to allow the system to determine relevancy of the content. An embodiment provides a forum for users to view and contribute content specifically tailored to individual entities, such that every instance of system content (including comments and votes) is related to one specific entity. An application may dynamically determine comment and vote time length. For example, if a user creates a comment on a popular Topic, the comment expiration time may be shorter, e.g. “Due to the current popularity of Topic: President Barack Obama, the comment time for this comment will be 22 minutes.” Application users cannot vote on their own comments. Once a comment exceeds its time limit, in an embodiment two hours, without receiving a vote, the comment expires. Comments may be ranked by either Recent or Popular. When ranking by popular, comments are ranked by total votes (either up or down votes) in the active time frame. These votes may be referred to as “active votes.”

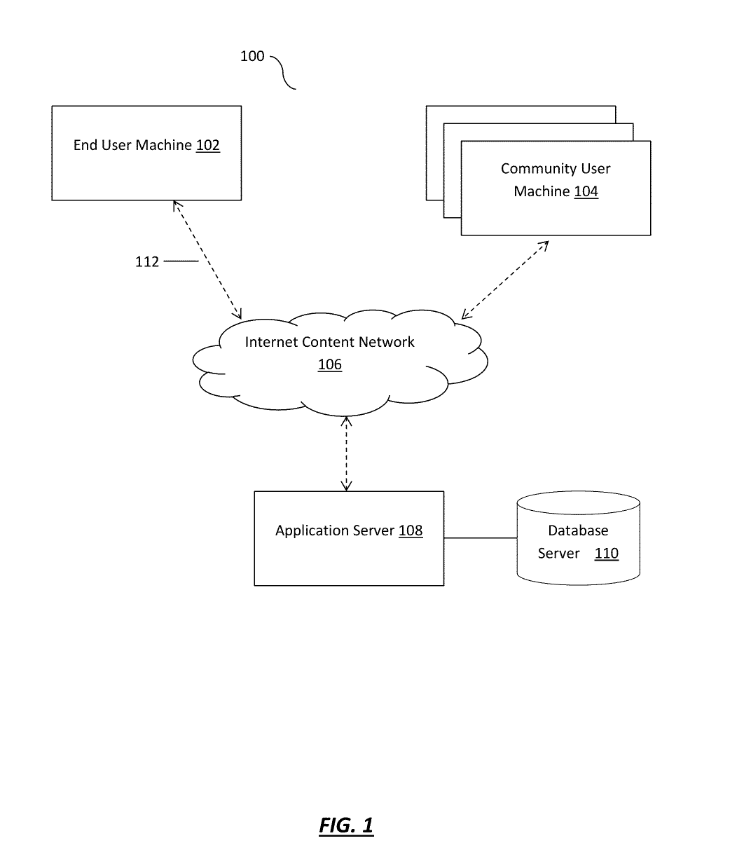

FIG. 1 is a block diagram of a voting and expiring Internet content ranking system in accordance with an embodiment. In an embodiment, system 100 represents a voting and expiring Internet content ranking system by which an end user machine 102 may submit and view targeted social media content delivered by an application server 108 over an Internet content network 106. End user machine 102 may represent any type of computing system and may be connected to one or more networks associated with the social media end user. In an embodiment, end user 102 includes a processing device, memory device, input/output (I/O) devices, and a network interface 112, each interconnected via a bus. The processing device may be a general-purpose of a specific purpose processor or microcontroller. The memory device may include one or more internally fixed storage units, removable storage units, and/or remotely accessible storage units. The storage units can be configured to store information, data, instructions, and/or software code. The storage units may include any combination of volatile memory, such as random access memory (RAM), dynamic RAM (DRAM), and/or non-volatile memory, such as read only memory (ROM), electrically erasable programmable ROM (EE-PROM), flash memory, and the like.

Database server 110 and application server 108, as well as community user machine 104, may be of the same form as end machine 102, and may store program code that enables the processing device to execute voting and content expiration procedures. Various logical instructions or commands may be included in the program code for delivering targeted social media content to an end user. The embodiments of the voting and expiring procedures described in the present disclosure can be implemented in hardware, software, firmware or a combination thereof. When implemented in software or firmware, the voting and expiration procedures or algorithms can be stored in the memory device and executed by the processing device.

According to an embodiment, end user machine 102 and community user machine 104 each contribute and view content over Internet content network 106 through network interface 112. Content viewed and contributed by end user machine 102 and community user machine 104 is received by application server 108 across Internet content network 106. Application server 108 may be operably or integrally engaged with database server 110 to store content and user parameter communicated over the network. Expiration algorithms, programs, or software, which can be partially or fully in a memory device on one or more of database server 110, application server 108, and end user machine 102, and any other computer code including executable logical instructions as described herein, can be embodied in computer-readable media for execution by any suitable processing device. The computer-readable media as described herein can include one or more suitable physical media components that can store the software, programs, or computer code.

I/O devices may include input mechanisms such as keyboards, keypads, cursor control devices, or other data entry devices. The input mechanisms may be used for entering set-up information for establishing matching rules and reconciliation rules. Input mechanisms may also be used to initiate financial reconciliation procedures and to access the results of financial reconciliation procedures. I/O devices also include output devices, which may be computer monitors, audio output devices, printers, and/or other peripheral devices. Network interface 112 includes components for accessing a network, such as a social media network or a user network associated with target social media content over an authorized user account.

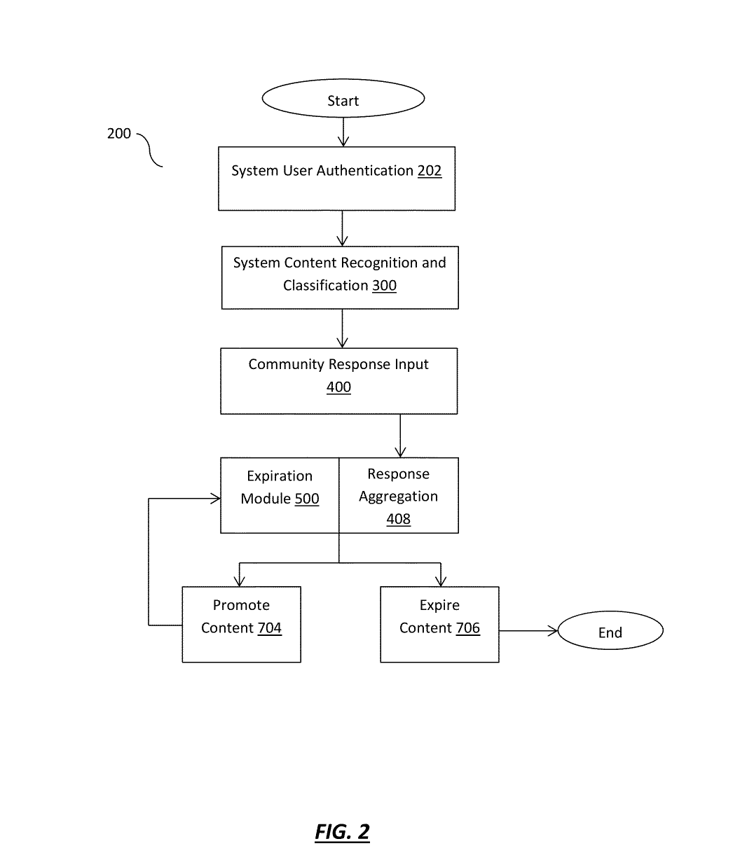

FIG. 2 is a logical flow diagram illustrating a voting and expiring Internet content ranking system in accordance with an embodiment. In an embodiment, a social media content delivery system 200 functions to deliver highly targeted and temporally relevant social media content to a system user. System 200 may function to aggregate related content and display only currently relevant ideas based on expiring comments and votes. Irrelevant content that is no longer supported by a community of users is demoted in a ranked user display, and ultimately removed if such content fails to receive community feedback.

In an embodiment, a user may interface with system 200 by inputting a system user authentication 202, which may include authentication protocols such as a user ID and password. An authenticated user may interface with a user account application to view targeted social media content based on identified account parameters. System 200 may function to deliver targeted social media content to a user by executing a system content recognition and classification module 300. System content and classification 300 may function to categorize content submitted by authenticated users, or incorporated by the system by linked or generated social media content from third-party social media platforms corresponding to specific entities or content categories. Social media content may be displayed across one or more Web pages through a Web application to enable a user to view and act upon the content. Social media content generated from system content recognition and classification 300 may receive community votes and comments through community response input module 400. Community response input 400 may include positive, negative or neutral votes in response to a social media content post, and may also include the ability to submit a response or sub-comment to the social media content post. Community response input 400 may be aggregated 408 in connection to a specific social media content post or thread to determine the number of community votes or comments. Response aggregation 408 may be used to form the basis of a raw score to determine relevance of a social media content post, the relevance score being used to determine the rank of displayed content over a user application. Values from community response input 400 and response aggregation 408 may interface with expiration module 500 to determine a content outcome comprised of promoting content 704 or expiring content 706. In an embodiment, expiration module 500 assigns a two hour timer application to a social media content post, and resets the timer application in response to a community user's vote or comment in response to the social media content post. The post is promoted 704 on the user application according the response aggregation 408 ranking as long as an active timing module exists. The post is continually be reevaluated for relevance through expiration module 500 as long as the content is present on the user application. If the timer in expiration module 500 expires, the content is expired 706 and removed from the user application, regardless of the ranking based on comment and vote volume. Expiration module 500 may have a longer or shorter timer application, and may assign different weight to votes and comments based on system and user parameters.

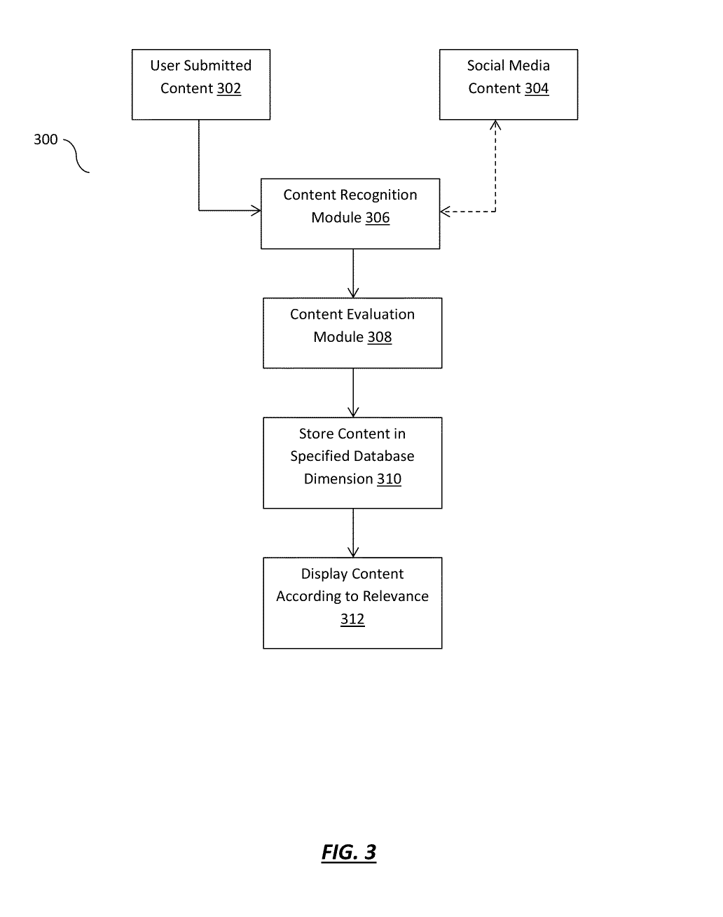

FIG. 3 is a logical flow diagram illustrating a routine of a voting and expiring Internet content ranking system in accordance with an embodiment. In an embodiment, a system content recognition and classification module 300 is operable to display content according to relevance 312 over a user application displayed over one or more Web pages in a user account interface. A content recognition module 306 may receive user submitted content 302 related to a specific entity or category over a social media platform. Content recognition module 306 may also may also link or otherwise input social media content 304 derived from third party social media platforms, including social networks, blogging systems, media sharing platforms, online forums, and meme aggregators. Social media content 304 may be derived from an Internet search engine crawling algorithm, or by user or administrator search parameters; or third-party social media accounts may be linked to the system by a user. Content recognition module 306 may input content to content evaluation module 308. Content evaluation module 308 classifies and categorizes content according to its relation to a specific entity and/or subject matter category. Content may be stored in a specified database dimension 310 according to content evaluation module 308 parameters. Dimensions in a content database are defined according to subject matter categories and specific entities. Database definitions may be determined by a user or by the system. Content may be displayed 312 according to relevance over a user application executing over one or more Web pages in a user account application. Relevance may be defined based on user-submitted relevance parameters or system administrator parameters.

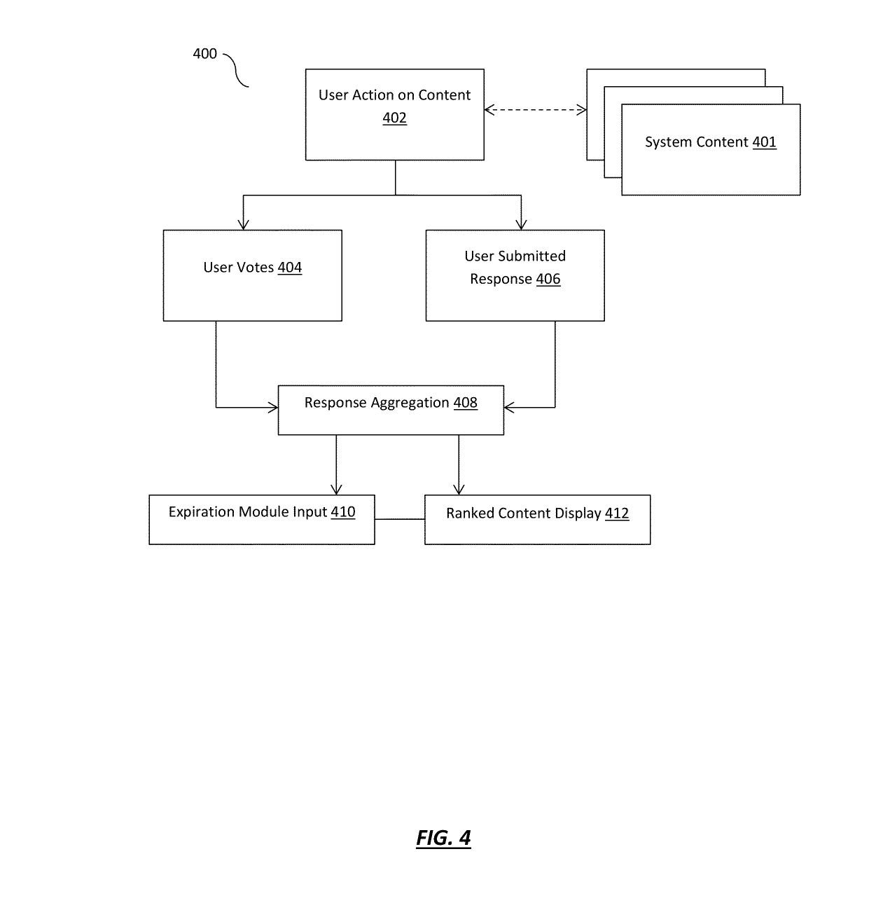

FIG. 4 is a logical flow diagram illustrating a routine of a voting and expiring Internet content ranking system in accordance with an embodiment. In an embodiment, community response input routine 400 is configured such that social media content, in particular relevant content 401 according to content recognition and classification module 300, is acted on 402 by a community of users on a social media platform. User action on content 402 may include user votes 404 and user submitted responses 406. User votes 404 may include positive, negative or neutral votes in response to a social media content post. User submitted responses 406 may include comments and sub-comments in response to system content 401 related to a specific subject matter category or specific entity. Votes 404 and responses 406 are aggregated 408 according to volume and weight of content. An administrator or end user may have the ability to give greater weight in an aggregation algorithm to comments or responses posted by important entities, such as a celebrity or politician. The response aggregation calculation 408 determines the order in which content is published over an end user application or ranked content display 412. Content with the highest aggregation values may be published at the top of a category or entity page in a ranked content display 412 in order to highlight the user community is reacting to that content more robustly than other content in the same category or entity page. Response aggregation values are used to form the basis of an expiration module input 410, which may be integrally engaged with ranked content display 412.

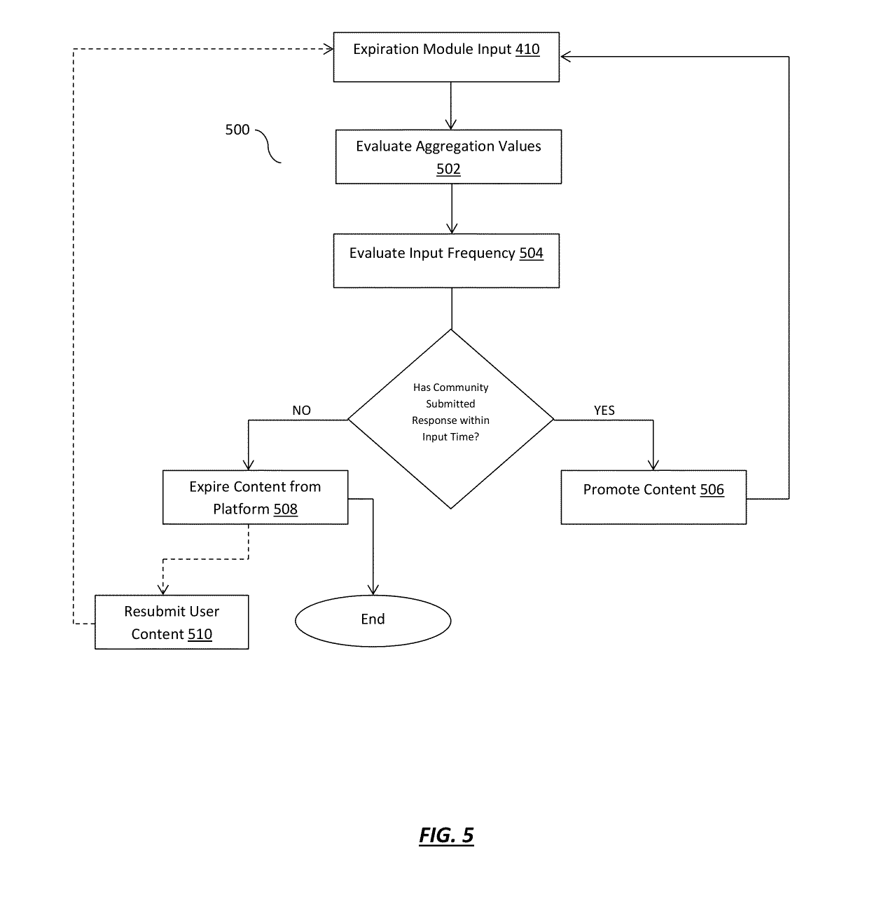

FIG. 5 is a logical flow diagram illustrating a routine of a voting and expiring Internet content ranking system in accordance with an embodiment. In an embodiment, an expiration module 500 is operable to promote social media content 506 over a user application or expire content 508 from a user application. Expiration module input 410 receives content aggregation values corresponding to the number and weight of votes and responses to categorized content over a user application. Expiration module 500 evaluates aggregation values 502 in order to assign a timer limit to responses or original content. In an embodiment, expiration module 500 assigns a timer to all content posted over a user application. Each instance in which a user votes or submits a response to published content the timer may be reset. This may be accomplished by continually monitoring response input frequency 504 by a timer algorithm executing over the user platform. Input frequency evaluation 504 functions to determine whether a user has submitted a vote or comment within the active timer window. If an active timer exists, the content is promoted 506 in accordance with the aggregation parameters and display parameters, and continually reincorporated as a content input in the expiration module 410. If no comment or vote has been logged by the system within the active timer window, the content is expired from the platform 508 and removed from the user application display. In the case where a user is also the content author, the user may resubmit the content post to the platform 510 and community users may have the opportunity to respond to the content through votes and comments. The response aggregation and frequency evaluation is conducted in the same manner as the original post.

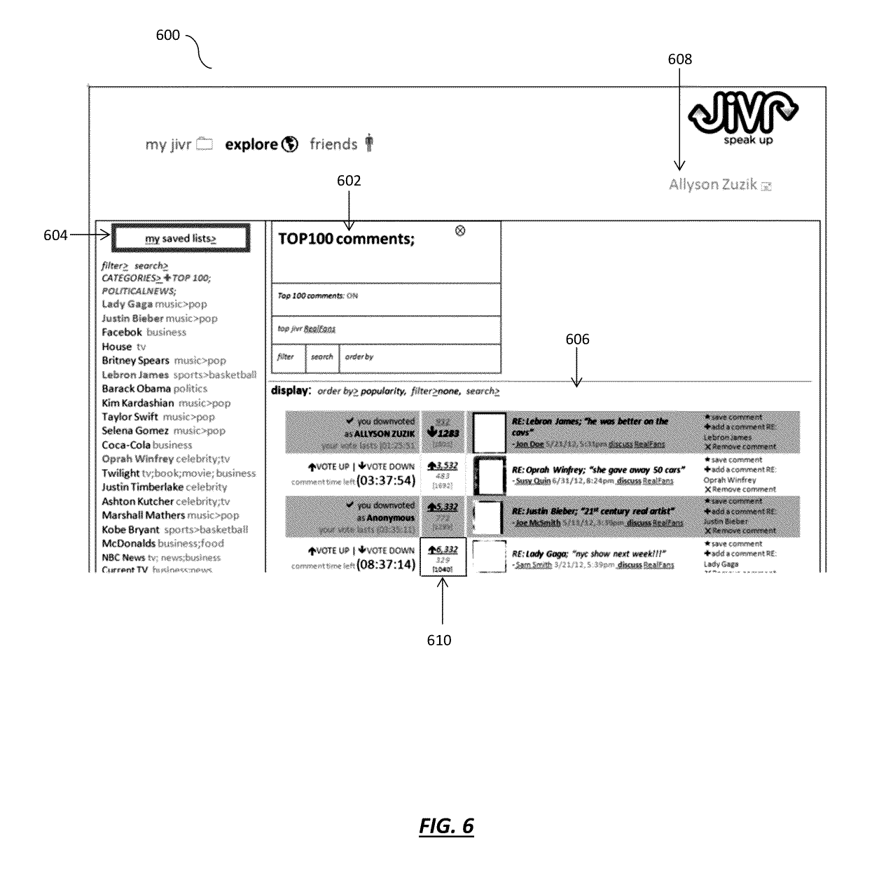

FIG. 6 is a diagram of a graphical user interface (GUI) for viewing targeted content and account settings in a social media platform in accordance with an embodiment. In an embodiment, a user application 600 is executing over one or more Web pages and accessed through an I/O device. In this example, application 600 allows an authenticated user 608 to view targeted content 602 and account settings 604. An application 600 may have a dashboard display, entities display, and comment display. A target content display 602 may deliver social media content that has been ranked according to aggregation and expiration parameters within a specific content category; in this example a “Top 100” category. Saved lists feed 604 may be configured to allow a user to select specific categories to follow. In this example, the content column displays a list of entities organized by comment aggregation values. “Lady Gaga” is the first on the list because in the last two hours there have been more votes on “Lady Gaga” comments than any other entity on the list. “Justin Bieber” is second on the list because “Justin Bieber” comments received the second highest number of votes of the selected entities, and so on and so forth in descending hierarchical order. Comments feed 606 displays comments directed to targeted content category 602. Comments are organized by total popularity. For example, the individual comment (regardless of entity) with the most votes in the past 12 hours will be on top. In this example, the comment relating to Lebron James “he was better on the Cavs,” received the most votes in the past two hours of any comment on the application. The comment relating to Oprah “she gave away 50 cars” received the second greatest votes in the last two hours. Vote aggregator display 610 indicates the total historical votes for the comment. Vote display 610 shows the total lifetime up-votes and down-votes for the comment. If there are more total up-votes than down-votes, the number of up-votes may display an up-arrow and may be in a different size or color font than the down votes. If there are more down-votes, a down arrow will be used. The number in brackets, e.g. [1040], indicates the number of votes within the timer window.

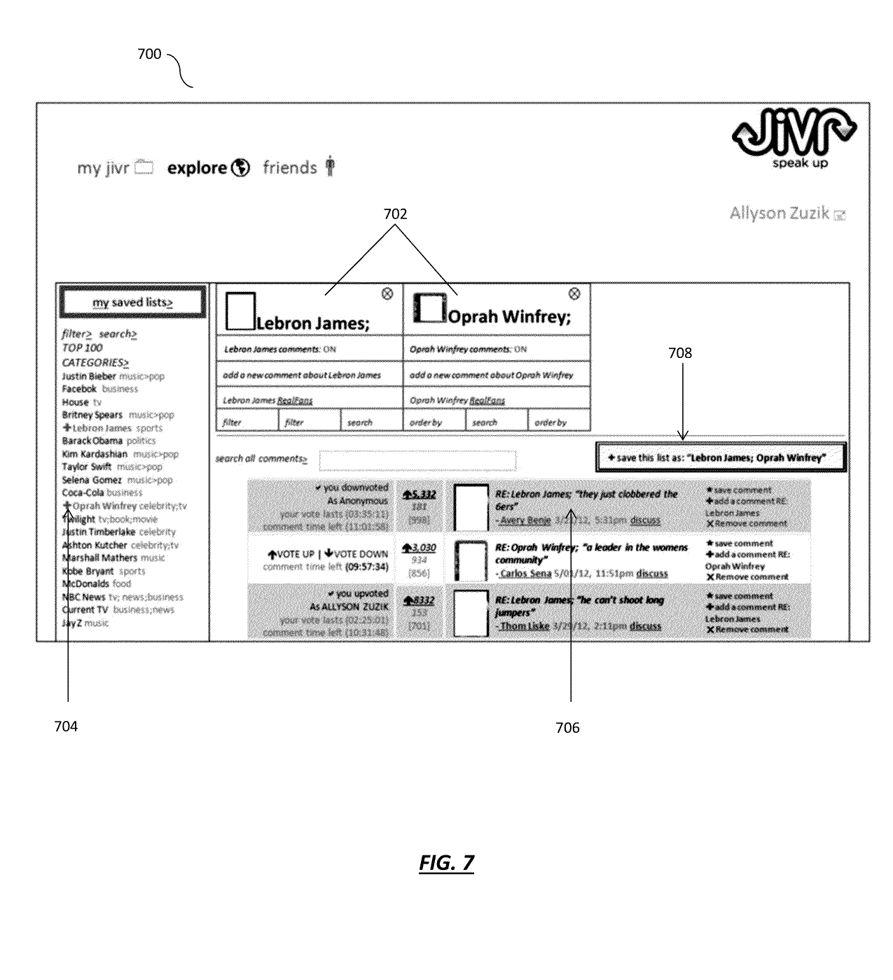

FIG. 7 is a diagram of a GUI for viewing targeted content and account settings in a social media platform in accordance with an embodiment. In an embodiment, application 700 enables a user select and view comments directed to specific entities 702 as well as view and act on entity comments 706. Viewed entities may be denoted by a symbol 704 in the category list. Users can act on entity comments 706 by filtering comments, such as recently authored or up-voted comments; search comments by author; and determine comment ranking. In the present example, Lebron James and Oprah Winfrey have been selected as entities 702. Both Lebron James and Oprah comments may be arranged by total popularity. For example, the single comment with the most votes in the past two hours will be displayed at the top of the list. User can save lists 708 to avoid manually selecting categories 702 multiple times.

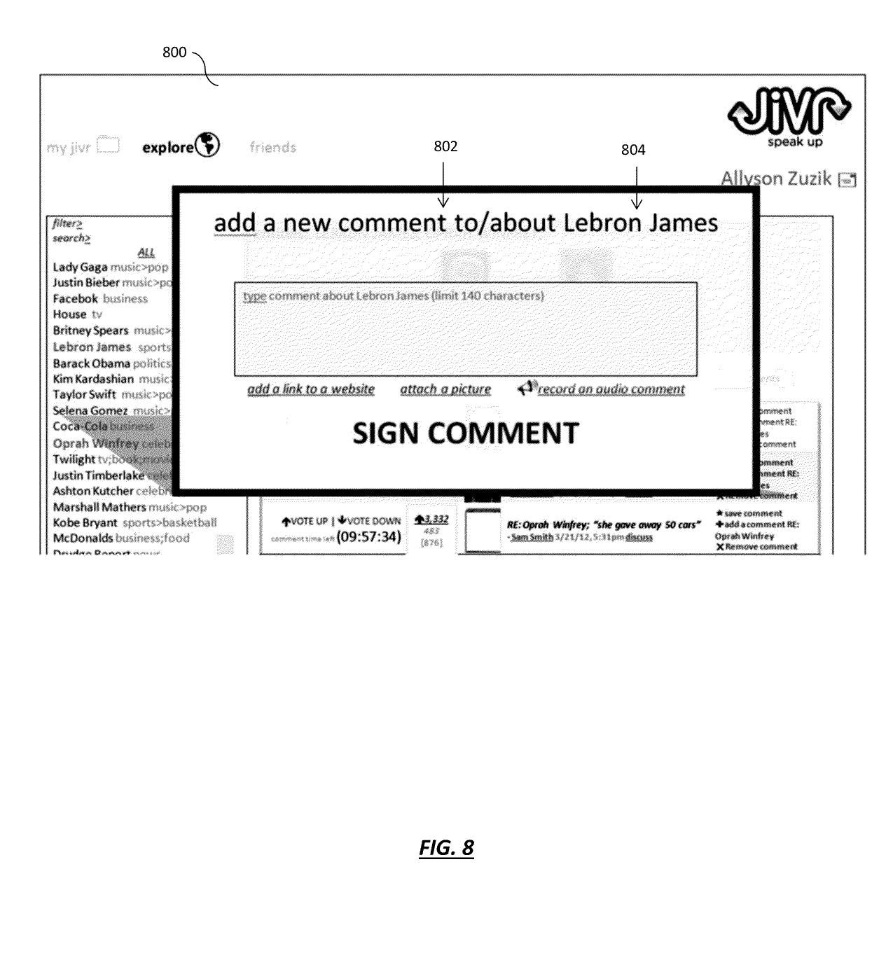

FIG. 8 is a diagram of a GUI for adding targeted content in a social media platform in accordance with an embodiment. In an embodiment, a comment field 800 enables a user to add a comment in connection to a selected entity 804. The user can navigate to an entity page, for example Lebron James, and click to “add a new comment about/to Lebron James,” and a comment prompt 802 is displayed. The user may select to submit a comment under a user name or as an anonymous user.

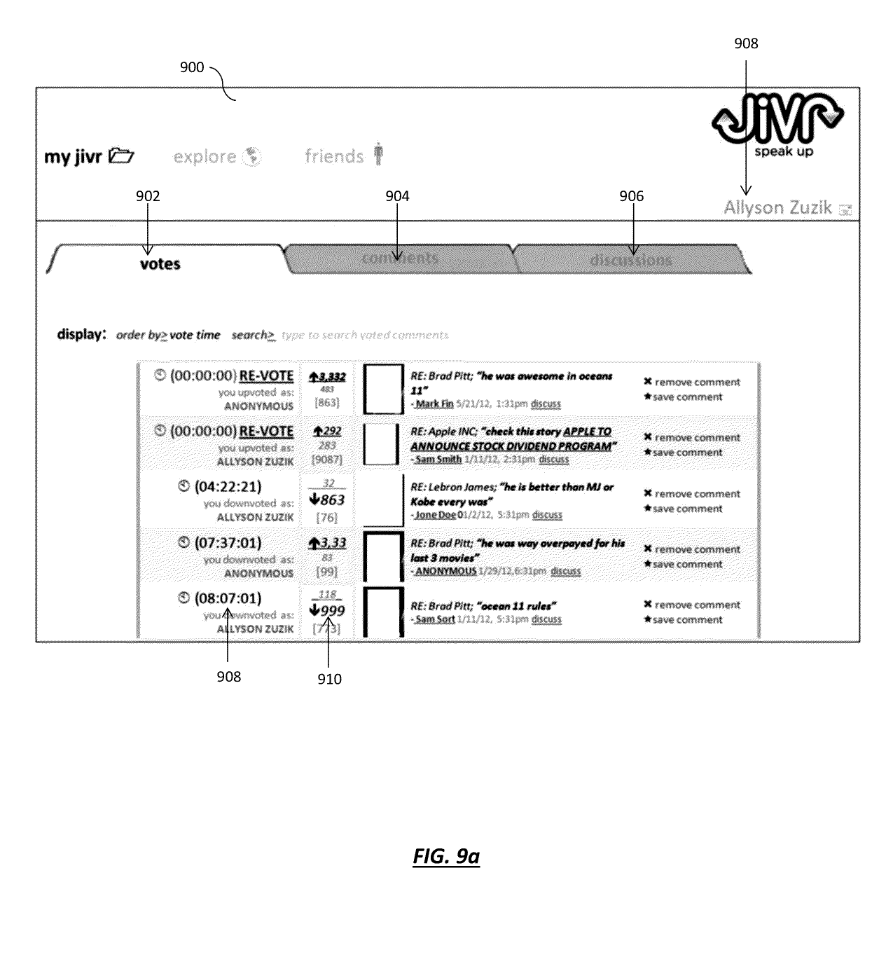

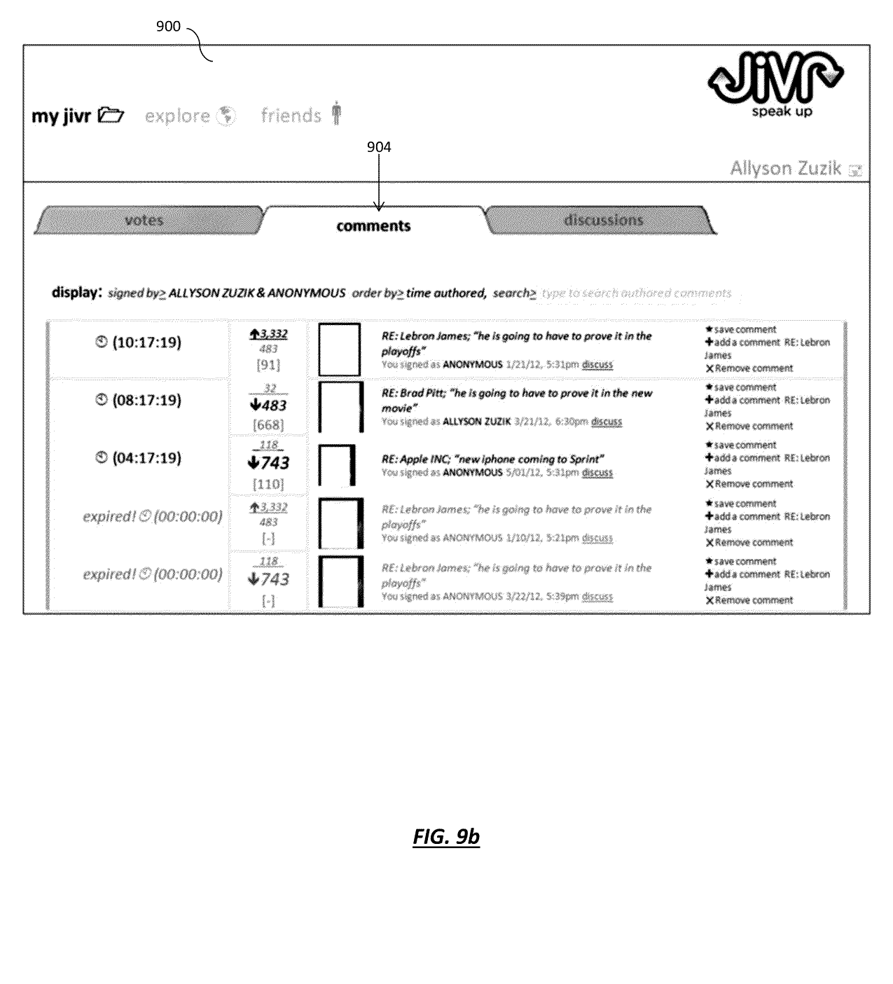

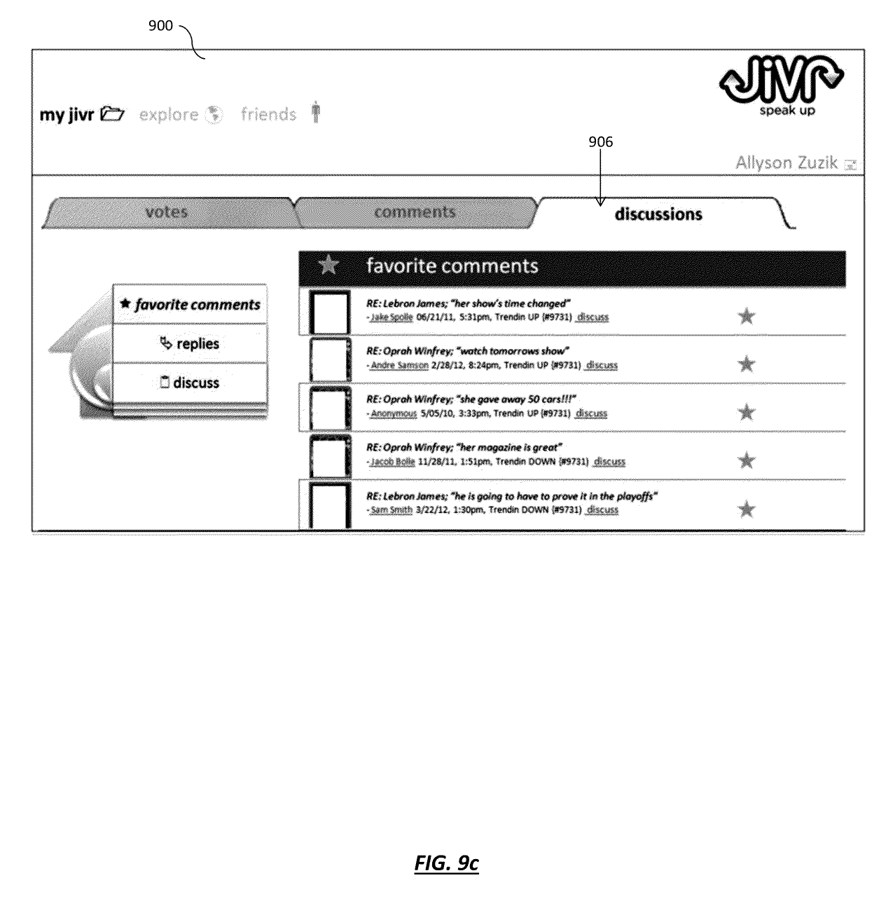

FIG. 9a is a diagram of a GUI for viewing content expiration and voting values in a social media platform in accordance with an embodiment. In an embodiment, a user application 900 is configured to allow an authenticated user to view and act on votes 902, comments 904, and discussions 906. In a votes tab view 902 a user can view its active votes to view the remaining time for a re-vote 908 and total vote statistics 910. FIG. 9b shows a comments tab view 904 where a user can save, add and/or remove comments it has submitted over a user application. FIG. 9c shows a discussions tab view 906 where a user can add or index favorite comments, comment replies, and comment discussions.

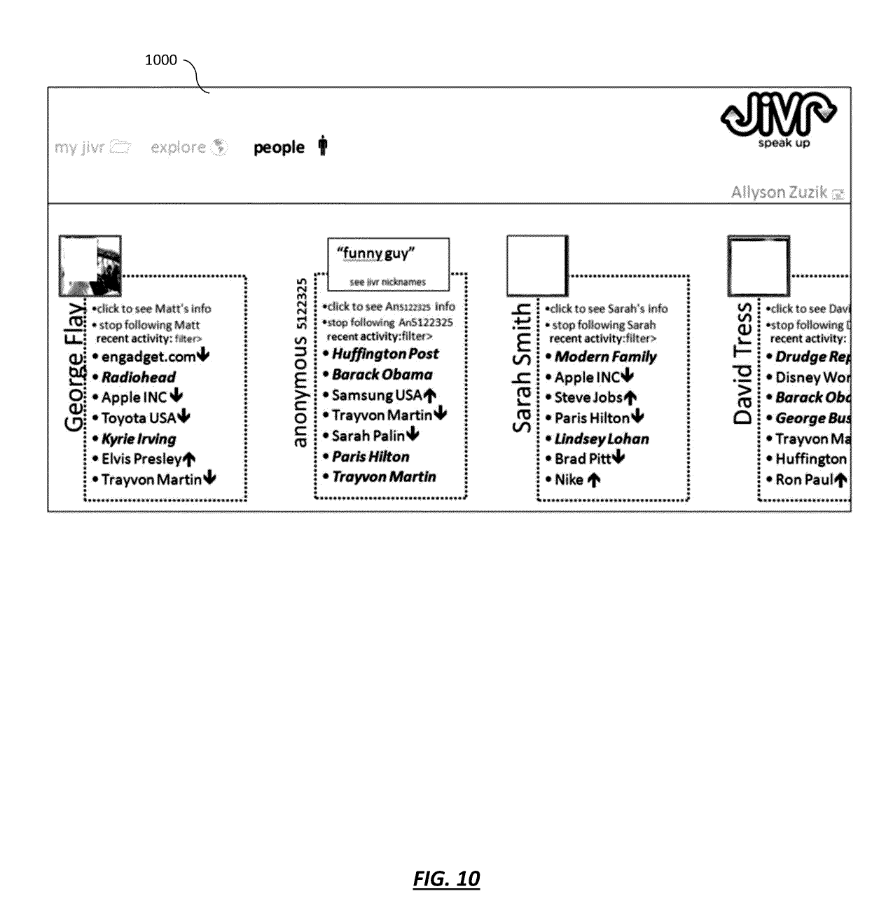

FIG. 10 is a diagram of a GUI for viewing user-targeted content in a social media platform in accordance with an embodiment. In an embodiment, a people tab view 1000 allows a user to view other application users' content lists. People tab 1000 is configured to enable a user to follow other users within the application, as well as access user information and recent activity.

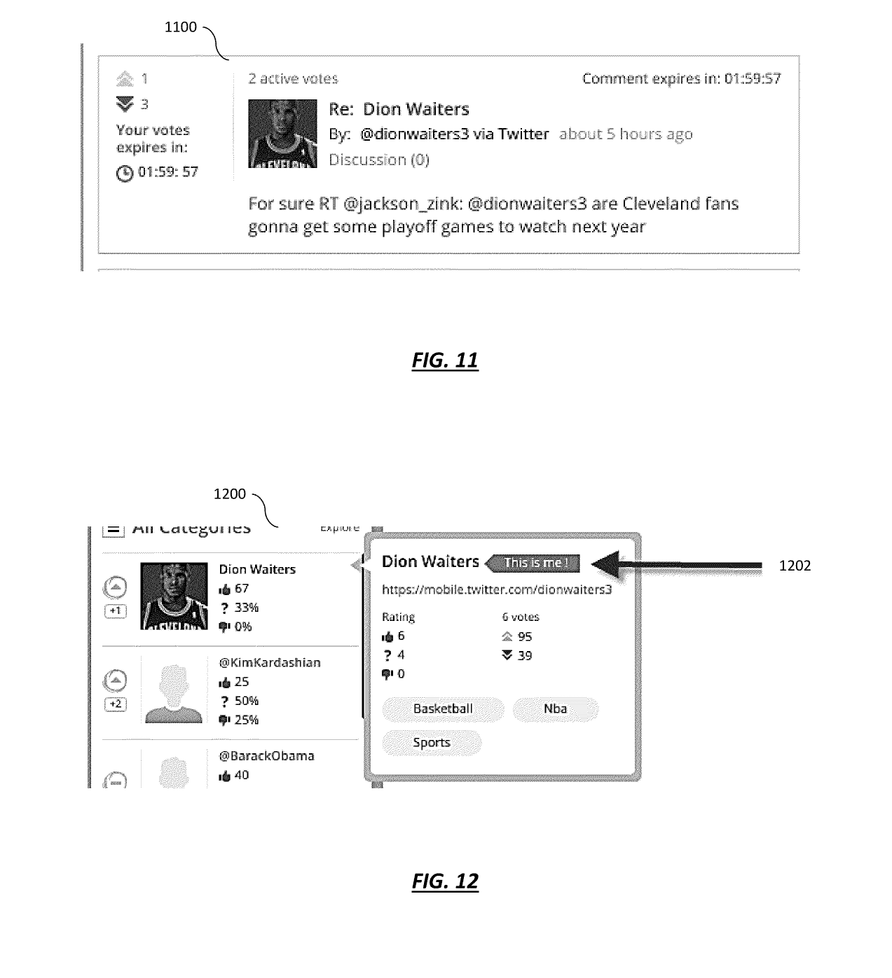

FIG. 11 is a diagram of a GUI for viewing user-submitted content in a social media platform in accordance with an embodiment. A content post 1100 shows the topic, author, comment expiration time, comment, and votes. FIG. 12 is a diagram of a GUI for responding to user-submitted content in a social media platform in accordance with an embodiment. In an embodiment, an user identification prompt allows Topics to “claim themselves” 1202 in an application by clicking on “this is me” and linking third-party social media accounts to their application account. Once a user claims the Topic, they can create an application comment response to any community comment about themselves. In an embodiment, only one account can claim each Topic in the application platform. This system creates a forum for a new type of dialogue between the community and the Topic. A Topic may navigate to a user application and see the current, most trending comment about them. The Topic can directly respond to any comment about them, and their response can be voted on by the community. A Topic user can delete any comment made about them in a community platform.

The embodiments described herein represent a number of implementation examples and are not intended to necessarily limit the present disclosure to any specific embodiments. Instead, various modifications can be made to these embodiments as would be understood by one of ordinary skill in the art. Any such modifications are intended to be included within the spirit and scope of the present disclosure and protected by the following claims.

What is claimed is:

1. A system for targeted social media content ranking comprising:
a content classification module, the content classification module being configured to accept a content input from a communications interface and classify the content input based on system and user parameters to determine content input relevance;
a multidimensional database engine, the multidimensional database engine being configured to store content input across dimensional hierarchies according to content category parameters communicated by the content classification module;
an applications module configured to display the content input stored in the multidimensional database engine across one or more Web pages, and accept a user action on displayed content over a graphical user interface; and,
an expiration module configured to aggregate the user actions on displayed content, the expiration module further comprising a timing module configured to assign a time limit on content input display over the applications module in response to the user action, the expiration module configured to remove content from the applications module in response to an expired content time limit.

2. The system of claim 1 wherein the applications module classifies a trending content input according to aggregation values generated by the expiration module.

3. The system of claim 1 wherein a user action is comprised of voting on displayed content and submitting a sub-thread corresponding to the displayed content.

4. The system of claim 1 wherein the content input is comprised of user-submitted content and system-generated content, the system-generated content being derived from social media content over the Internet according to social media content parameters.

5. The system of claim 2 wherein the applications module is further configured to recognize an authorized end user within an end-user account interface.

6. The system of claim 4 wherein the social media content relates to a specified content category or entity.

7. The system of claim 5 wherein the applications module is configured to display the trending content input in accordance with end-user parameters communicated over the end-user account interface.

8. The system of claim 5 wherein the applications module is further configured to enable the authorized end user to link an end-user social networking account to the end-user account interface.

9. The system of claim 7 wherein the trending content input is displayed dynamically based on aggregation and expiration parameters configured by the system.

10. A system for analyzing a social media of postings published over a Web platform comprising:
an aggregation module, the aggregation module configured to aggregate content threads and sub-threads of social media postings, and a plurality of votes submitted by Internet users in response to the content threads and sub-threads; and,
a timing module, the timing module configured to assign a timer to the content threads and sub-threads in response to submission by an Internet user over the Web platform, the timer being reset in response to a vote submission, and further configured to remove content from the Web platform in response to timer expiration.

11. The system of claim 10 wherein the aggregation module is further configured to display the content threads and sub-threads over one or more Web pages wherein the content threads with a greater plurality of votes are emphasized in a user display over content threads with a lesser plurality of votes.

12. The system of claim 10 further comprising a multidimensional database engine, the multidimensional database engine being configured to store the content threads and sub-threads across dimensional hierarchies according to content category parameters.

13. The system of claim 10 wherein the content threads and sub-threads of social media postings are organized according to a specific entity classification.

14. The system of claim 11 wherein the content threads and sub-threads are displayed dynamically based upon system aggregation and timing parameters.

15. The system of claim 13 wherein the Internet user may submit and organize content thread and sub-thread submissions according to an end-user account interface.

16. A computer-implemented method for delivering targeted social media content to a user comprising:
aggregating comments and user votes in response to a social media posting;
ranking the social media posting based on comment and user vote parameters, the parameters being manipulated dynamically based on content classification and system administrator settings;
displaying the social media posting over one or more Web pages according to ranking parameters; and,
removing the social media posting from the one or more Web pages according to relevance parameters determined by a timing module, the timing module being configured to set a relevance time limit according to a frequency of comments and user votes in response to the social media posting.

17. The method of claim 16 further comprising creating a user profile such that an end-user can configure content parameters based on category and entity.

18. The method of claim 16 further comprising organizing a plurality of social media postings by subject matter parameters.

19. The method of claim 17 further comprising indexing end user content parameters such that subjective data points may be assigned based on user category and entity configurations.

20. The method of claim 17 wherein the social media posting is generated from user-submitted content and system-generated content, the system-generated content corresponding with category and entity parameters.
